(19) United States
(12) Patent Application Publication
(10) Pub. No.: US 2006/0139831 A1
(43) Pub. Date: Jun. 29, 2006

(54) Electrical subassembly and use thereof

(76) Inventors: Philipp Huemer, Graz (AT); David Connett, Neubiberg (DE); Mike Morianz, Graz (AT); Siegfried Fellner, St. Georgen (AT)

Correspondence Address: FISH & RICHARDSON PC, P.O. BOX 1022, MINNEAPOLIS, MN, 55440-1022, US

(21) Appl. No.: 10/528,040

(22) PCT Filed: Sep. 17, 2003
(86) PCT No.: PCT/DE03/03097

§ 371 Date: Sep. 16, 2005

(30) Foreign Application Priority Data
Sep. 17, 2002 (DE) 102431132

(51) Int. Cl. H02H 5/04

(52) U.S. Cl. 361/103

(57) ABSTRACT

An assembly includes a first electrical component having a first electrical property, a second electrical component having a second electrical property, where the first electrical property and the second electrical property are substantially identical, a housing that holds the first electrical component and the second electrical component, first terminals on the housing that contact the first electrical component, and second terminals on the housing that contact the second electrical component.

The present invention pertains to an electric component assembly with two electric components. In addition, the component assembly contains terminals for contacting the components. The invention also pertains to the utilization of the component assembly.

It is common practice to utilize thermistors as fault protection elements in telephone lines. These thermistors are also referred to as PTCs (Positive Temperature Coefficient) and represent components, the resistance of which has a positive temperature coefficient. Under an electrical load, the resistance of PTCs increases such that this high load can then be blocked.

Thermistors are required for protecting telephone lines from impermissible loads, for example, lightning strikes, surges, contacts between telephone lines and power lines, switching overvoltages, induced voltages or the like. The thermistors are usually installed in a telecommunication switching station.

In the fault protection of telephone lines, both lines of a telephone connection are respectively protected separately. This means that two thermistors are required in order to ensure the desired protection. However, a telephone connection needs to be realized symmetrically in order to prevent undesirable interferences such as crosstalk between the telephone lines. This can be achieved by matching the resistance values of the two thermistors used for the individual telephone lines. The matching of the electrical resistance values of the thermistors is usually carried out at a temperature of 25° C.

In the manufacture of thermistors, the resistance values of the thermistors drift around 25° C. within a certain range. This is the reason why thermistors are sorted into so-called resistance classes after their manufacture. The deviation between two resistance values within a resistance class cannot exceed a certain value specified by the user. This value may lie, for example, at 1Ω.

It is also known to separately connect two matched thermistors to the respective telephone lines of a telephone connection on a printed circuit board. This task is usually carried out by automated component insertion machines. The automated component insertion machines require special programs in order to ensure that the resistance values of both telephone lines are matched in the required fashion. These programs ensure that only matched fault protection elements are respectively inserted on the printed circuit board adjacent to one another in order to form part of one telephone connection.

When exchanging the belts, in which the fault protection elements are usually delivered to the automated component insertion machines, it may occur that mismatched thermistors are inserted adjacent to one another. This source of errors is particularly disadvantageous because it necessitates a subsequent check and, if so required, the exchange of thermistors.

In addition, two matched fault protection elements respectively need to be exchanged when a printed circuit board requires subsequent processing, namely because this represents the only option for ensuring that the resistance values also remain matched in the future.

The present invention is based on the objective of disclosing a component assembly that is suitable for protecting telephone lines and in which the risk of mismatched fault protection elements is reduced.

This objective is attained with a component assembly according to claim 1. Advantageous embodiments of the component assembly as well as the utilization thereof are disclosed in the dependent claims.

The electric component assembly according to the invention comprises a housing that contains at least two identical electric components. The electric components are matched with respect to one parameter. The component assembly also contains terminals suitable for separately contacting each individual component.

The component assembly provides the advantage that it contains two matched electric components. This makes it possible to populate a printed circuit board with fault protection elements for protecting telephone lines in one production step, namely in such a way that each of the two telephone lines is connected to one electric component of the component assembly. This ensures that only matched electric components are always contacted with the two telephone lines of a telephone connection.

The electric component assembly also provides the advantage that the insertion of both electric components can be realized in one production step. This advantageously lowers the manufacturing costs for protected telephone lines.

In comparison with two separate protection elements, the electric component assembly also provides the advantage of a reduced space requirement on the printed circuit board to be populated with the electric component assembly.

To that effect, it is advantageous that both electric components consist of thermistors, the resistance values of which are matched at a certain temperature.

It is also advantageous that the resistance values are matched at a temperature of 25° C.

At this point, it should be noted that the term thermistor refers to an electric component, the electrical resistance of which has a positive temperature coefficient (Positive Temperature Coefficient=PTC). In addition, the thermistor has such a resistance/temperature characteristic that its resistance increases with the temperature. When subjected to a load, the temperature of the thermistor rises such that its resistance increases.

It is also quite advantageous that the resistance values of both electric components deviate by no more than 1Ω. This ensures that both thermistors of a component assembly belong to the same resistance class, and that both thermistors are suitable for populating a printed circuit board that is used for contacting telephone lines belonging to the same telephone connection.

In one embodiment of the component assembly, the upper side of the housing is realized such that the orientation of the component assembly can be detected with the aid of a camera. This can be realized, for example, by providing the upper side of the housing with a geometric shape that is not completely symmetrical. This makes it possible to distinguish between at least two different lateral faces of the component assembly. In this respect, it would be possible, for example, to realize the upper side of the housing in the form of a rectangle.

It is also advantageous that the housing of the component assembly is at least partially realized in a contact-voltage proof fashion.

A housing that functions in such a contact-voltage proof fashion can be realized, for example, by closing at least one lateral face of the housing. The contact-voltage proofing function can be advantageously improved by closing two faces of the housing. These two faces may consist, for example, of the upper side of the housing and one other lateral face. In one advantageous embodiment of the component assembly, the upper side of the housing is contact-voltage proofed and can be simultaneously utilized as an alignment mark for a camera.

Cameras are usually utilized in instances, in which printed circuit boards are populated with components or component assemblies by means of automated component insertion machines. For example, the camera recognizes a component delivered to the automated component insertion machine on a conveyor belt. The camera is able to detect the orientation of a component assembly provided with an alignment mark. This ensures that the automated component insertion machine is able to take hold of and insert the component on the printed circuit board in the correctly oriented position.

In another embodiment of the component assembly, the terminals are arranged on one side of the housing, preferably the underside. The arrangement of the terminals is chosen such that the component assembly can only be inserted on a printed circuit board in the correctly oriented position. Such a suitable design of the terminals makes it possible to additionally reduce the risk of component insertion errors.

In another embodiment of the component assembly, a flashover protection in the form of a partition wall of an insulating material is provided between the components. Such a partition wall makes it possible to partially or entirely prevent flashovers between the two electric components.

It is also advantageous that the housing consists of a hardly inflammable material. A hardly inflammable housing could consist, for example, of a LCP (Liquid Crystal Polymer) material that conforms to fire protection standard UL94-V0.

It is also advantageous that the terminals are realized such that the component assembly can be surface-mounted. This provides the advantage that a printed circuit board can be populated with the component assembly by means of an efficient and economical surface mounting technique. The manufacturing costs of protected telephone lines can be additionally lowered in this fashion.

The invention also discloses the utilization of the component assembly, wherein the utilization consists of populating a printed circuit board. The electric components contained in the component assembly are respectively connected to one data transmission line. At least two of the lines are assigned to the same data terminal.

The described utilization provides the advantage that two telephone lines can be connected to matched electric components. This makes it possible to lower the error quota in the populating of printed circuit boards used for protecting telephone lines. In addition to the two components required for protecting two telephone lines, the component assembly may also contain other components.

Embodiments of the invention are described in greater detail below with reference to the corresponding figures.

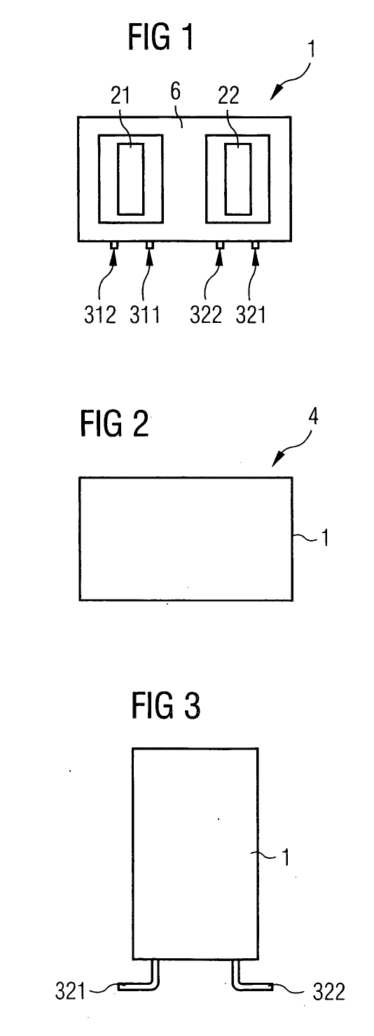

FIG. 1 shows an example of the component assembly in the form of a side view;

FIG. 2 shows a top view of the component assembly according to FIG. 1;

FIG. 3 shows a side view of the component assembly according to FIG. 1;

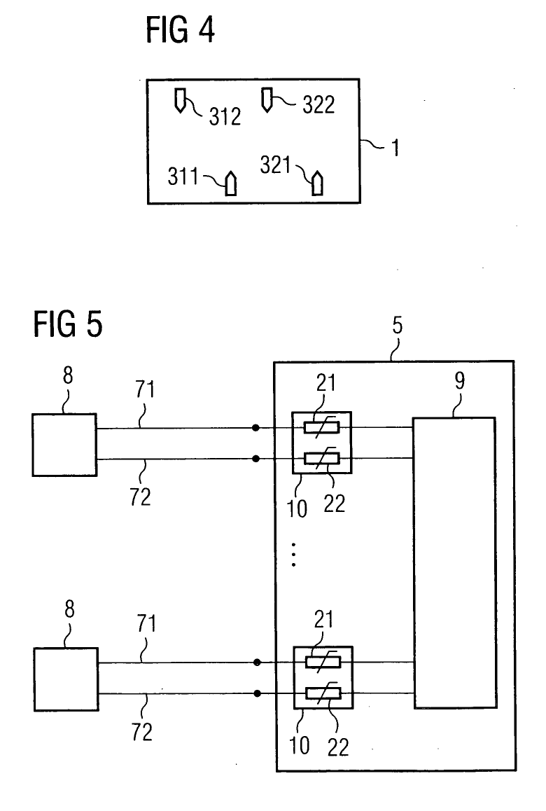

FIG. 4 shows a bottom view of the component assembly according to FIG. 1, and

FIG. 5 shows a printed circuit board populated with the component assembly according to FIG. 1.

FIG. 1 shows a component assembly with a housing 1. The housing 1 contains two cavities, wherein an electric component 21, 22 is arranged in each cavity. The electric components 21, 22 consist of thermistors. The two electric components 21, 22 are separated from one another by a partition wall 6. The partition wall 6 serves as a flashover protection between the two electric components 21, 22.

Terminals 311, 312, 321, 322 are provided on the underside of the housing 1 and only indicated schematically in FIG. 1. The terminals 311, 312, 321, 322 are realized in such a way that each electric component 21, 22 can be contacted separately. This can be achieved, for example, by assigning the two terminals 311, 312 to the electric component 21 and the two terminals 321, 322 to the electric component 22. In the simplest configuration, two of the contacts 311, 312; 321, 322 are respectively contacted with the external contacts of one component 21, 22.

FIG. 2 shows a top view of the component according to FIG. 1. In this figure, the upper side of the housing 1 has the contour of a rectangle 4. This figure also shows that the housing 1 is closed on the upper side of the component assembly. Since the upper side of the housing 1 has the shape of a rectangle 4, its orientation can be recognized by a camera, namely because a rectangle does not have sides of equal length, but rather shorter and longer sides. A camera is able to determine the orientation of the component based on the different side lengths.

Since the upper side of the housing 1 is closed, the top of the component assembly is realized in a contact-voltage proof fashion.

It is also advantageous that the upper surface of the housing 1 contains a defined planar contact surface for the suction device of an automated component insertion machine. This makes it possible to simplify the populating of a printed circuit board with the electric component assembly. The upper side shown in FIG. 2 forms a suitable contact surface. The planar portion of the total surface of the upper side may also be a realized smaller depending on the respective suction device.

FIG. 3 shows a side view of the component assembly, wherein the two terminals 321, 322 are also illustrated in this figure in addition to the housing 1 and another closed side of the housing 1. The two terminals 321, 322 are bent outward shortly after extending out of the underside of the housing 1, namely in such a way that the two terminals can be surface-mounted on a printed circuit board. The two bent sections of the terminals 321, 322, in particular, approximately lie in one plane. The terminals 311, 312 may be realized analogously, wherein the terminals 311, 312 also contain sections that are bent outward or inward, and wherein the bent sections of all terminals 311, 312, 321, 322 approximately lie in one plane in order to ensure that the component assembly can be surface-mounted. For example, the terminals may consist of copper. The housing may consist, for example, of plastic.

The design of the terminals 311, 312, 321, 322 mentioned above with reference to FIG. 3 is described in greater detail below with reference to FIG. 4 that shows a bottom view of the component assembly. FIG. 4 shows a certain arrangement of the terminals 311, 312, 321, 322 on the underside of the housing 1. In this case, the terminals 311, 312, 321, 322 are arranged in such a way that the component assembly can only be inserted on the printed circuit board in a certain orientation. For example, if the contact surfaces on the printed circuit board are designed accordingly, it is not possible to solder the component assembly in position such that its underside is turned by 90° relative to the correctly oriented position shown in FIG. 4 in the clockwise or the counterclockwise direction.

FIG. 5 shows a printed circuit board 5 with a central unit 9 arranged thereon. The printed circuit board 5 may consist, for example of a so-called line card as it is typically utilized for telecommunication purposes. Several such line cards are combined and correspondingly wired together in a data interface, for example, a switching station. Each line card carries a central unit 9. Such a central unit 9 may consist, for example, of a logic circuit for establishing calls between different telephone connections.

Data terminals 8 are connected to the printed circuit board 5 via lines 71, 72. In this case, each data terminal 8 usually comprises a pair of lines 71, 72. The data terminal 8 may consist, for example, of a private telephone connection. In addition, a protective circuit is provided between each connection of a data terminal 8 and the central unit 9, wherein said protective circuit protects the data terminal 8 from lightning strikes, overcurrents and the like as described above. The protective circuit may comprise gas-type surge protectors, Zener diodes or other suitable components. It also comprises, in particular, the component assembly described above with reference to FIGS. 1-4, namely multiple component assemblies of this type such that one component assembly 10 is available for each data terminal 8.

Each component assembly 10 contains a pair of electric components 21, 22 that consist, for example, of PTC resistors. In this case, each electric component 21, 22 is respectively connected in series to a line 71, 72 leading to the corresponding data terminal 8 in each component assembly 10. The component assembly 10 may be fixed on the printed circuit board 5, for example, by means of a surface-mounting technique.

The utilization of the described component assembly 10 for populating a printed circuit board 5 with data lines provides the advantage that two lines 71, 72 of a telephone connection can be respectively connected to matched electric components 21, 22 in only one production step. This makes it possible to practically eliminate component insertion errors, particularly mismatches between the electric components 21, 22 assigned to the lines 71, 72.

Instead of being connected to the data terminals 8, the printed circuit board 5 or the line card, respectively, may also be connected to other line cards or switching components.

1. An assembly comprising:
a first electrical component having a first electrical property;
a second electrical component having a second electrical property, the first electrical property and the second electrical property being substantially identical;
a housing that holds the first electrical component and the second electrical component;
first terminals on the housing that contact the first electrical component; and
second terminals on the housing that contact the second electrical component.

2. The assembly of claim 1, wherein the first electrical component and the second electrical component comprise thermistors, and the first electrical property and the second electrical property comprise a first resistance and a second resistance, respectively, at a predefined temperature.

3. The assembly of claim 2, wherein the predefined temperature is 25° C.

4. The assembly of claim 3, wherein the first resistance and the second resistance deviate by no more than 1Ω.

5. The assembly of claim 1, wherein the housing has an upper side with a shape that is indicative of an orientation of the housing.

6. The assembly of claim 5, wherein the upper side of the housing is rectangular in shape.

7. The assembly of claim 1, wherein the housing has an underside, the first and second terminals being on the underside of the housing; and
wherein the first and second terminals have an arrangement that corresponds to an arrangement of contacts on a printed circuit board.

8. The assembly of claim 5, wherein the upper side of the housing is closed.

9. The assembly of claim 1, wherein the housing comprises a partition made of electrically insulating material, the partition being between the first and second electrical components, the partition acting as a flashover protection between the first and second electrical components.

10. The assembly of claim 1, wherein the housing comprises plural sides, at least one side of the housing being closed.

11. The assembly of claim 1, wherein the housing comprises a material that is substantially inflammable.

12. The assembly of claim 1, wherein the first and second terminals are configured for surface mounting of the assembly.

13. Circuitry comprising:
a first data transmission line;
a second data transmission line;
a data terminal connected to the first and second data transmission lines; and
an assembly that connects a printed circuit board to the first and second data transmission lines, the assembly comprising:
a first electrical component having a first electrical property; and
a second electrical component having a second property, the first electrical property and the second electrical property being substantially identical;
wherein the first electrical component connects the first transmission line to the printed circuit board, and the second electrical component connects the second transmission line to the printed circuit board.

14. The assembly of claim 5, wherein the upper side of the housing comprises a planar sections; and
wherein the assembly further comprises an automated component insertion machine attached to the planar section via suction.

15. The circuitry of claim 13, wherein the first electrical component and the second electrical component comprise thermistors, and the first electrical property and the second electrical property comprise a first resistance and a second resistance, respectively, at a predefined temperature.

16. The circuitry of claim 15, wherein the predefined temperature is 25° C.

17. The circuitry of claim 16, wherein the first resistance and the second resistance deviate by no more than 1Ω.

18. The circuitry of claim 13, wherein the assembly further comprises:
a housing that holds the first electrical component and the second electrical component, the housing comprising a partition made of a material that is substantially electrically insulating, the partition being between the first and second electrical components.

19. The circuitry of claim 13, wherein the first data transmission line and the second data transmission line comprise telephone lines.

20. The circuitry of claim 13, further comprising:
the printed circuit board, the assembly being mounted on the printed circuit board via mating connections on the assembly and the printed circuit board.
